(19) United States
(12) Patent Application Publication
(10) Pub. No.: US 2010/0211454 A1
(43) Pub. Date: Aug. 19, 2010

(54) METHOD FOR PROPOSING ADVERTISEMENT KEYWORD AND SYSTEM THEREOF

(75) Inventors: Hyun Chul Shin, Kyunggi-do (KR); Khu Jin Ahn, Kyunggi-do (KR); Kyungsun Ko, Kyunggi-do (KR)

Correspondence Address: HUSCH BLACKWELL SANDERS LLP, 190 Carondelet Plaza, Suite 600, ST. LOUIS, MO, 63105, US

(73) Assignee: NHN BUSINESS PLATFORM CORPORATION, Kyunggi-do (KR)

(21) Appl. No.: 12/673,444

(22) PCT Filed: Jun. 24, 2008
(86) PCT No.: PCT/KR2008/003579

§ 371 Date: Mar. 9, 2010

(30) Foreign Application Priority Data
Aug. 14, 2007 (KR) 10-2007-0081797

(51) Int. Cl. G06Q 30/00

(52) U.S. Cl. 705/14.42

(57) ABSTRACT

Disclosed are a method and system for proposing an advertisement keyword. The method includes receiving an input of a keyword associated with a new advertiser, extracting a representative keyword from among advertisement keywords of an existing advertiser having an outcome of a prescribed reference value or more, comparing a keyword inputted in association with the new advertiser and the representative keyword of the existing advertiser, determining whether the new advertiser has the same business category as that of the existing advertiser based on the compared result, designating a predetermined keyword-set as a business category keyword based on the determined result, and proposing the advertisement keyword to the new advertiser based on a result obtained by analyzing the business category keyword.

### TECHNICAL FIELD

The present invention relates to a method and system for proposing an advertisement keyword which may ascertain a business category of an advertiser to propose a keyword suitable for the business category of the advertiser, and more particularly, to a method and system for proposing an advertisement keyword which may determine the business category of the advertiser based on the compared result between a keyword inputted by a new advertiser and a representative keyword of an existing advertiser.

### BACKGROUND ART

In general, advertisement methods using the Internet may be performed such that an advertisement keyword purchased by an advertiser is inputted as a query, and an advertisement registered by the advertiser is exposed based on the searched result of the query.

However, according to the above-mentioned conventional advertisement method, there is a burden in that the advertiser has to directly select and purchase an advertisement keyword corresponding to an advertisement to be exposed. Also, according to the conventional advertisement method, advertisement effect may be deteriorated when the advertisement keyword selected by the advertiser is not a popular keyword or has a poor association with the business category of the advertiser. In addition, according to the conventional advertisement method, the advertiser has to disadvantageously purchase the advertisement keyword one by one.

Accordingly, there is a high need for a method for proposing an advertisement keyword being suitable for the business category of the advertiser by determining the business category of the advertiser.

### DISCLOSURE OF INVENTION

### Technical Goals

An aspect of the present invention provides a method and system for proposing an advertisement keyword which may compare a keyword inputted by a new advertiser and a representative keyword of an existing advertiser to determine a business category of the new advertiser, thereby proposing an advertisement keyword suitable for the determined business category of the new advertiser.

An aspect of the present invention provides a method and system for proposing an advertisement keyword which may propose, to the new advertiser, keywords having advertisement effect verified by the existing advertiser as an advertisement keyword.

An aspect of the present invention provides a method and system for proposing an advertisement keyword which may compare only advertisement keywords of the existing advertiser even without directly finding keywords of the business category by the new advertiser to determine the business category of the new advertiser.

An aspect of the present invention provides a method and system for proposing an advertisement keyword which may analyze the advertisement keyword of the existing advertiser, thereby proposing, to the new advertiser, an advertisement keyword having a high association with the business category.

### Technical Solutions

According to an aspect of the present invention, there is provided a method for proposing an advertisement keyword, the method including: receiving an input of a keyword associated with a new advertiser; extracting a representative keyword from among advertisement keywords of an existing advertiser having an outcome of a prescribed reference value or more; comparing a keyword inputted in association with the new advertiser and the representative keyword of the existing advertiser; determining whether the new advertiser has the same business category as that of the existing advertiser based on the compared result; designating a predetermined keyword-set as a business category keyword based on the determined result; and proposing the advertisement keyword to the new advertiser based on a result obtained by analyzing the business category keyword.

According to an aspect of the present invention, there is provided a system for proposing an advertisement keyword, the system including: a keyword inputting unit to receive an input of a keyword associated with a new advertiser; a representative keyword extracting unit to extract a representative keyword from among advertisement keywords of an existing advertiser having an outcome of a prescribed reference value or more; a keyword comparing unit to compare a keyword inputted in association with the new advertiser and the representative keyword of the existing advertiser; a business category determining unit to determine whether the new advertiser has the same business category as that of the existing advertiser according to the compared result; a business category keyword designating unit to designate a predetermined keyword-set as a business category keyword according to the determined result; and an advertisement keyword proposing unit to propose the advertisement keyword to the new advertiser based on a result obtained by analyzing the business category keyword.

### Advantageous Effects

As described above, according to the present invention, there is provided the method and system for proposing the advertisement keyword which may determine the business category of the advertiser to propose advertisement keywords suitable for the determined business category, thereby reducing burdens in which the advertiser has to purchase the advertisement keyword one by one.

According to the present invention, there is provided the method and system for proposing the advertisement keyword which may propose, to the new advertiser, the keywords having verified advertisement effects as the advertisement keywords, thereby enabling an advertisement to be operated with low costs by proposing the keyword without automatic exposure.

According to the present invention, there is provided the method and system for proposing the advertisement keyword which may compare the advertisement keywords of the existing advertiser and new advertiser even without the new advertiser directly selecting the business category keyword, thereby ascertaining the business category of the new advertiser.

According to the present invention, there is provided the method and system for proposing the advertisement keyword which may analyze the advertisement keywords of the existing advertiser to thereby propose the keyword having high association with the business category to the new advertiser.

### BRIEF DESCRIPTION OF DRAWINGS

FIG. 1 is a diagram illustrating an interworking relation of a new advertiser, an existing advertiser, and an advertisement keyword proposing system according to an exemplary embodiment of the present invention;

FIG. 2 is a diagram illustrating an example of advertisement keywords selected by an existing advertiser in the existing advertiser's terminal;

FIG. 3 is a diagram illustrating an example of keywords inputted by a new advertiser in the new advertiser's terminal;

FIG. 4 is a diagram illustrating an example of keywords collected from an existing advertiser's keyword pool having a conformity rate among keywords of a reference value or more in an advertisement keyword proposing system;

FIG. 5 is a diagram illustrating a configuration of an advertisement keyword proposing system according to an exemplary embodiment of the invention; and

FIG. 6 is a flowchart illustrating an advertisement keyword proposing method according to an exemplary embodiment of the invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

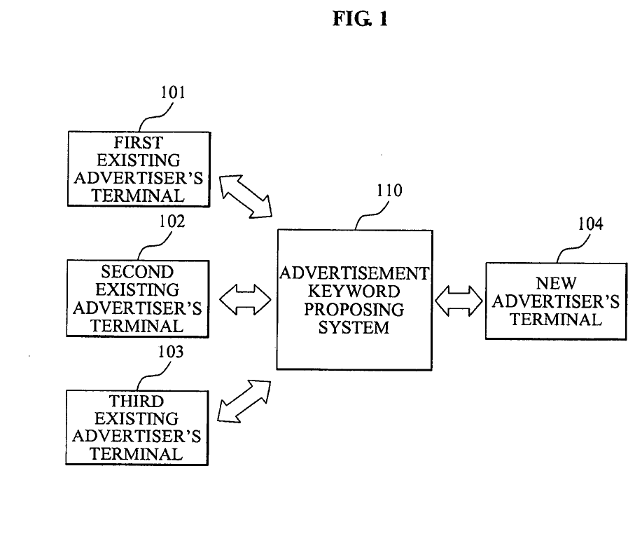

FIG. 1 is a diagram illustrating an interworking relation of a new advertiser, an existing advertiser, and an advertisement keyword proposing system 110 according to an exemplary embodiment of the present invention.

Referring to FIG. 1, each of a first to third existing advertiser's terminals 101, 102, and 103 is a high performance advertiser satisfying a Pay per Click (PPC) and a number of clicks or keywords which are a predetermined reference value or more, and provides an advertisement keyword to the advertisement keyword proposing system 110.

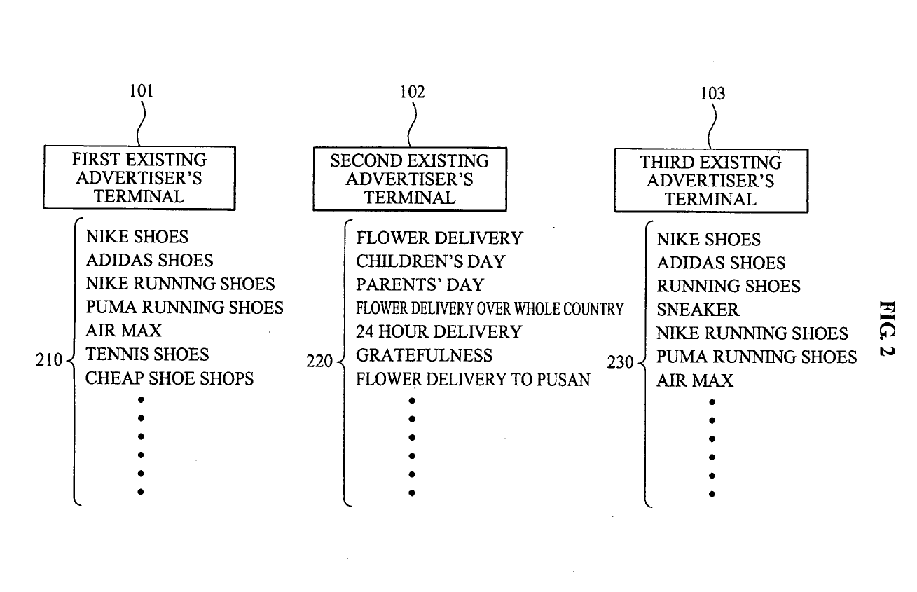

FIG. 2 is a diagram illustrating an example of advertisement keywords selected by an existing advertiser in the existing advertiser's terminal.

Referring to FIG. 2, the first existing advertiser's terminal 101 provides, to the advertisement keyword proposing system 110, an advertisement keyword pool such as a first advertisement keyword 210 such as Nike shoes, Adidas shoes, Nike running shoes, Puma running shoes, Air Max, tennis shoes, cheap shoe shops, and the like. Specifically, the first existing advertiser's terminal 101 may provide, to the advertisement keyword proposing system 110, the first advertisement keyword 210 selected by the first existing advertiser, that is, a running shoe shopping mall of a high performance satisfying the PPC and the number of clicks or keywords of the predetermined reference value or more.

The second existing advertiser's terminal 102 provides, to the advertisement keyword proposing system 110, an advertisement keyword pool of a second advertisement keyword 220 such as flower delivery, children's day, parents' day, flower delivery over whole country, 24 hour delivery, gratefulness, flower delivery to Pusan, and the like. Specifically, the second existing advertiser's terminal 102 may provide, to the advertisement keyword proposing system 110, the second advertisement keyword 220 selected by a second existing advertiser, that is, a flower delivery shopping mall of a high performance satisfying the PPC and the number of clicks or keywords of the predetermined reference value or more.

The third existing advertiser's terminal 103 provides, to the advertisement keyword proposing system 110, an advertisement keyword pool of a third advertisement keyword 230 such as Nike shoes, Adidas shoes, running shoes, sneakers, Nike running shoes, Puma running shoes, Air Max, and the like. Specifically, the third existing advertiser's terminal 103 may provide, to the advertisement keyword proposing system 110, the third advertisement keyword 230 selected by the third existing advertiser, that is, a running shoe shopping mall of a high performance satisfying the PPC and the number of clicks or keywords of the predetermined reference value or more.

As described above, the advertisement keyword proposing system 110 may be provided with the advertisement keywords 210 to 230 from the existing advertiser's terminals 101 to 103 of the high performance satisfying the PPC and the number of clicks or keywords of the predetermined reference value or more.

A new advertiser's terminal 104 receives an input of keywords from a new advertiser intending to effectuate a predetermined number of new advertisement, and provides the received keywords to the advertisement keyword proposing system 110. Specifically, the new advertiser's terminal 104 receives an input of keywords associated with the new advertiser. As an example, the new advertiser's terminal 104 may directly receive the input of keywords from the new advertiser, receive an input of keywords used for selecting a business category intending to effectuate a new advertisement, or receive an input of keywords extracted by analyzing a home page of the new advertiser.

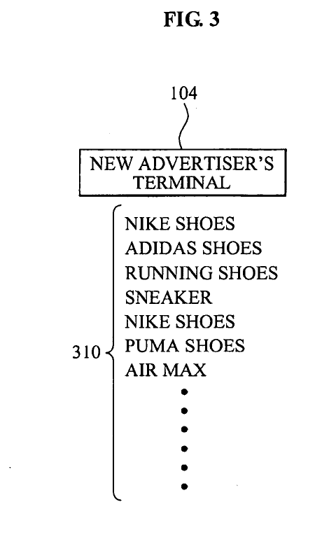

FIG. 3 is a diagram illustrating an example of keywords inputted by a new advertiser in the new advertiser's terminal.

Referring to FIG. 3, the new advertiser's terminal 104 inputs, to the advertisement keyword proposing system 110, representative keywords 310 such as Nike shoes, Adidas shoes, running shoes, sneakers, Nike running shoes, Puma running shoes, Air Max, and the like. Specifically, the new advertiser's terminal 104 may receive an input of a prescribed minimum number of the representative keywords 310 from the new advertiser, receive an input of keywords used for selecting a business category, or receive an input of keywords extracted by analyzing a home page of the new advertiser. Then, the new advertiser's terminal 104 may input the received keywords to the advertisement keyword proposing system 110.

As described above, the advertisement keyword proposing system 110 may receive the input of a prescribed minimum number of the representative keywords from the new advertiser, intending to effectuate a new advertisement, using the new advertiser's terminal 104, receive the input of keywords used for selecting the business category, or receive the input of keywords extracted by analyzing the home page of the new advertiser.

The advertisement keyword proposing system 110 extracts representative keywords from among advertisement keywords 210 to 230 of the existing advertiser's terminals 101 to 103 having an outcome of a prescribed reference value or more. Specifically, the advertisement keyword proposing system 110 may extract, as the representative keywords, a top keyword for sales of a predetermined reference value or more from among the advertisement keywords of the existing advertiser satisfying Pay Per Click (PPC) and a number of clicks or keywords which are greater than or equal to a prescribed reference value.

The advertisement keyword proposing system 110 compares a keyword inputted in association with the new advertiser from the new advertiser's terminal 104 and the representative keyword of the existing advertiser. Specifically, the advertisement keyword proposing system 110 may compare the representative keyword, that is, the top keyword for sales from among the advertisement keywords 210 to 230 of the existing advertiser's terminals 101 to 103 and keywords inputted from the new advertiser's terminal 104. As an example, according to the compared result between the first advertisement keyword 210 of the first existing advertiser's terminal 101 and the keywords inputted from the new advertiser's terminal 104 in the advertisement keyword proposing system 110, when the first advertisement keyword 210 and the inputted keyword are the same, a conformity rate among the keywords may be 100%. As another example, according to the compared result between the second advertisement keyword 220 of the second existing advertiser's terminal 102 and the keyword inputted from the new advertiser's terminal 104 in the advertisement keyword proposing system 110, when the second advertisement keyword 220 and the inputted keyword are different from each other, the conformity rate among the keywords may be 0%. As still another example, according to the compared result between the third advertisement keyword 230 of the third existing advertiser's terminal 103 and the keywords inputted from the new advertiser's terminal 104 in the advertisement keyword proposing system 110, when the third advertisement keyword 230 and the inputted keyword have seven identical keywords from among ten keywords, the conformity rate among the keywords may be 70%.

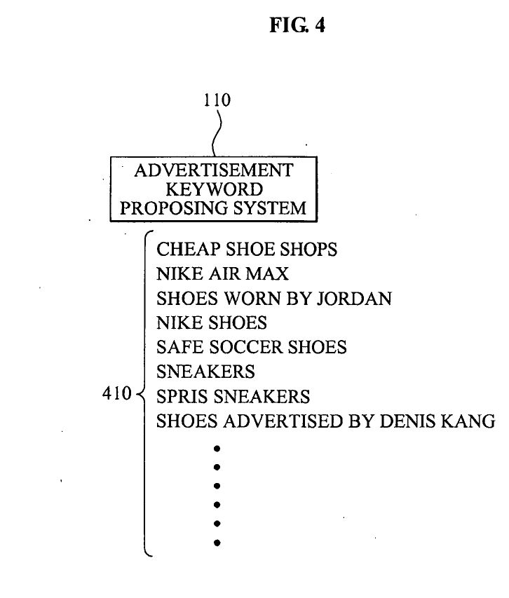

FIG. 4 is a diagram illustrating an example of keywords collected from an existing advertiser's keyword pool having a conformity rate among keywords of a reference value or more in an advertisement keyword proposing system.

Referring to FIG. 4, according to the compared result between the representative keywords of the existing advertiser's terminals 101 to 103 and the keywords inputted from the new advertiser's terminal 104, the advertisement keyword proposing system 110 may collect keywords whose conformity rate exceeds a prescribed reference value such as cheap shoe shops, Nike Air Max, shoes worn by Jordan, safe soccer shoes, sneakers, Spris sneakers, shoes advertised by Denis Kang, and the like.

The advertisement keyword proposing system 110 determines whether the new advertiser has the same business category as that of the existing advertiser according to the above-described compared result. Specifically, the advertisement keyword proposing system 110 may determine that the new advertiser has the same business category as that of the existing advertiser when a conformity rate among the keywords exceeds a prescribed reference value according to the compared result between the keyword inputted from the new advertiser and the representative keywords of the existing advertiser. As an example, according to the compared result therebetween, when a business category of the existing advertiser's terminal having the conformity rate among the keywords of 70% or more is a running shoe shopping mall, the advertisement keyword proposing system 110 may determine that a business category of the new advertiser is the running shoe shopping mall identical to that of the existing advertiser. Also, the advertisement keyword proposing system 110 may determine that the new advertiser has a new business category different from the business category of the existing advertiser, when the conformity rate among the keywords is less than a prescribed reference value according to the compared result between the representative keywords of the existing advertiser and the keywords inputted from the new advertiser. As an example, according to the compared result therebetween, the advertisement keyword proposing system 110 may determine that the new advertiser has a new business category different from that of the existing advertiser, when the conformity rate among the keywords is less than 70%.

The advertisement keyword proposing system 110 designates a predetermined keyword-set as a business category keyword based on the determined result of whether the new advertiser and the existing advertiser have the same business category. As an example, the advertisement keyword proposing system 110 may designate a keyword-set operated by the existing advertiser as a business category keyword when the existing advertiser and the new advertiser have the same business category. As an example, the advertisement keyword proposing system 110 may designate a keyword-set extracted by analyzing a home page of the new advertiser as the business category keyword, when the new advertiser has a new business category.

The advertisement keyword proposing system 110 proposes the advertisement keywords to the new advertiser based on the analyzed result of the business category keyword. Specifically, the advertisement keyword proposing system 110 may propose, to the new advertiser, remaining business category keywords acting as the advertisement keyword. In this instance, the remaining business category keywords may be obtained by eliminating a business category keyword in which a click through rate within a fixed period is less than or equal to a prescribed reference value based on the analyzed result of the business category keyword. As an example, the advertisement keyword proposing system 110 may provide, to the new advertiser's terminal 104, the remaining business category keywords, obtained by eliminating business category keywords in which a click through rate within the past three months is less than or equal to a prescribed reference value based on the analyzed result of the business category keyword, as the advertisement keywords. Also, the advertisement keyword proposing system 110 may propose, to the new advertiser, business category keywords designated depending on the analyzed result of the home page of the new advertiser as the advertisement keyword, when the new advertiser has a new business category.

The advertisement keyword proposing system 110 automatically sets an advertisement group using the proposed advertisement keyword to thereby expose an advertisement. Specifically, the advertisement keyword proposing system 110 may automatically set the proposed advertisement keywords as an advertisement group or advertisement campaign to thereby be operated by the advertiser.

As described above, the advertisement keyword proposing system 110 according to the present exemplary embodiment of the invention may determine the business category of the new advertiser, and propose the advertisement keyword suitable for the determined business category to the new advertiser.

Also, the advertisement keyword proposing system 110 according to the present exemplary embodiment of the invention may reduce burdens in that the conventional advertiser has to directly select the business category keyword, and propose advertisement keywords with respect to the business category keywords verified as having a high association in an associated keyword scheme.

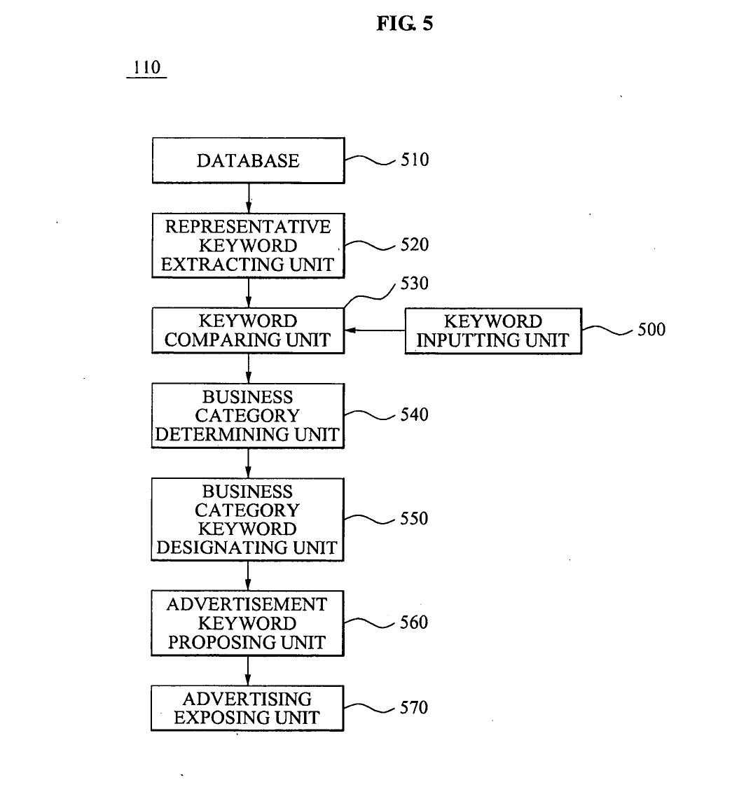

FIG. 5 is a diagram illustrating a configuration of an advertisement keyword proposing system according to an exemplary embodiment of the invention.

Referring to FIG. 5, the advertisement keyword proposing system 110 includes a keyword inputting unit 500, a database 510, a representative keyword extracting unit 520, a keyword comparing unit 530, a business category determining unit 540, a business category keyword designating unit 550, an advertisement keyword proposing unit 560, and an advertising exposing unit 570.

The keyword inputting unit 500 receives an input of a keyword associated with a new advertiser. Specifically, as illustrated in FIG. 3, the keyword inputting unit 500 may receive the input of the keyword from the new advertiser, receive the input of keywords used for selecting the business category, or receive the input of keywords extracted by analyzing the home page of the new advertiser.

The database 510 records and maintains the advertisement keywords selected from the existing advertiser as illustrated in FIG. 2. Also, according to the compared result between the advertisement keywords selected from the existing advertiser as illustrated in FIG. 2 and the keywords inputted from the new advertiser as illustrated in FIG. 3, the database 510 may collect a keyword pool having a conformity rate among the keywords greater than or equal to a prescribed reference value, and record and maintain the collected keyword poll as business category keyword database as illustrated in FIG. 4.

The representative keyword extracting unit 520 extracts a representative keyword from advertisement keywords of the existing advertiser having an outcome greater than or equal to a prescribed reference value. Specifically, the representative keyword extracting unit 520 may extract, as the representative keyword, a top keyword for sales greater than or equal to a prescribed reference value from among the advertisement keywords of the existing advertiser satisfying a Pay Per Click (PPC) and a number of keywords or clicks which are greater than or equal to a prescribed reference value.

The keyword comparing unit 530 compares a keyword inputted in association with the new advertiser and the representative keyword of the existing advertiser. Specifically, the keyword comparing unit 530 may compare the representative keyword, that is, the top keyword for sales from among the advertisement keywords 210 to 230 of the existing advertiser's terminals 101 to 103 and the keyword inputted from the new advertiser's terminal 104.

The business category determining unit 540 determines whether the new advertiser has the same business category as that of the existing advertiser according to the compared result. Specifically, according to the compared result between the keyword inputted from the new advertiser and the representative keyword of the existing advertiser, the business category determining unit 540 may determine that the new advertiser has the same business category as that of the existing advertiser when a conformity rate among the keywords is greater than or equal to a prescribed reference value. As an example, according to the compared result therebetween, the business category determining unit 540 may determine that the business category of the new advertiser is a running shoe shopping mall which is the same as that of the existing advertiser, when the business category of the existing advertiser having the conformity rate of 70% or more is the running shoe shopping mall. Also, according to the compared result therebetween, the business category determining unit 540 may determine that the new advertiser has a new business category different from that of the existing advertiser, when the conformity rate is less than a prescribed reference value.

The business category keyword designating unit 550 designates a predetermined keyword-set as a business category keyword based on the determined result of whether the new advertiser and the existing advertiser have the same business category. As an example, the business category keyword designating unit 550 designates a keyword-set operated by the existing advertiser as the business category keyword, when the new advertiser has the same business category as that of the existing advertiser. Specifically, the business category keyword designating unit 550 may extract a business category with respect to the existing advertiser and designate the extracted business category as the business category keyword by retaining a business category keyword-set by an internal criterion or utilizing a keyword map, when the new advertiser has the same business category as that of the existing advertiser. As an example, the business category keyword designating unit 550 may designate a keyword-set extracted by analyzing a home page of the new advertiser as the business category keyword.

The advertisement keyword proposing unit 560 proposes the advertisement keyword to the new advertiser based on the result obtained by analyzing the business category keyword. Specifically, the advertisement keyword proposing unit 560 may propose, to the new advertiser, a remaining business category keyword acting as the advertisement keyword. In this instance, the remaining business category keyword is obtained by eliminating a business category keyword in which a click through rate within a fixed period is less than or equal to a prescribed reference value based on the analyzed result of the business category keyword. Also, the advertisement keyword proposing unit 560 may propose, to the new advertiser, the business category keyword designated depending on the analyzed result of the home page of the new advertiser acting as the advertisement keyword, when the new advertiser has a new business category.

The advertisement exposing unit 570 automatically sets an advertisement group using the proposed advertisement keyword to thereby expose an advertisement. Specifically, the advertisement exposing unit 570 may automatically set the proposed advertisement keyword as an advertisement group or advertisement campaign to thereby be operated by the advertiser.

As described above, the advertisement keyword proposing system 110 according to the present exemplary embodiment of the invention may generate a keyword group or campaign optimized for the corresponding business category through business category option check or keyword automatic registration option of the advertiser, and the generated keyword group or campaign may be automatically set to be operated.

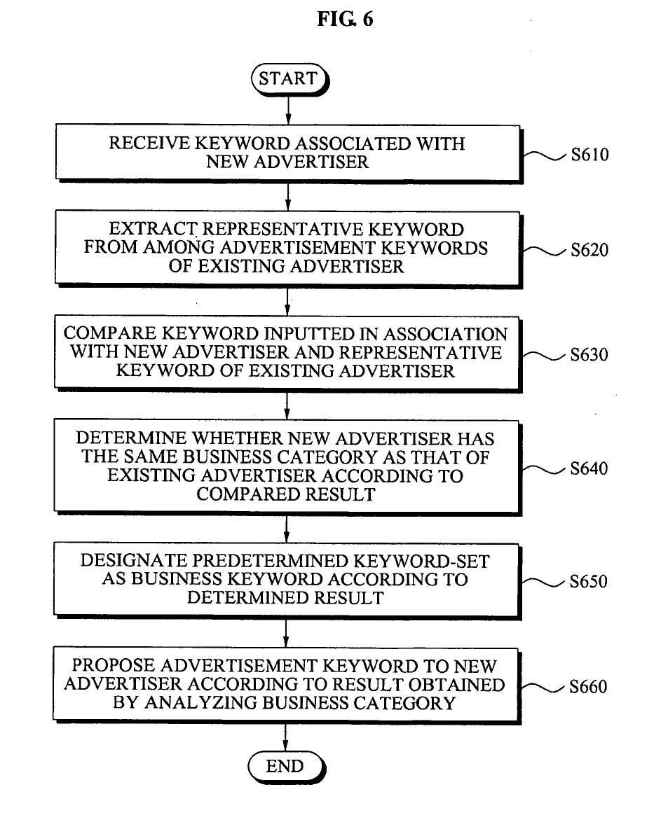

FIG. 6 is a flowchart illustrating an advertisement keyword proposing method according to an exemplary embodiment of the invention.

Referring to FIG. 6, in operation S610, the advertisement keyword proposing system receives an input of a keyword associated with the new advertiser. Specifically, in operation S610, the advertisement keyword proposing system may receive an input of a predetermined minimum number of representative keywords from the new advertiser, receive an input of keywords used for selecting a business category, or receive an input of keywords extracted by analyzing the home page of the new advertiser.

In operation S620, the advertisement keyword proposing system extracts representative keywords from among advertisement keywords of the existing advertiser having an outcome greater than or equal to a prescribed reference value. Specifically, in operation S620, the advertisement keyword proposing system may extract, as the representative keyword, a top keyword for sales of a predetermined reference value or more from among the advertisement keywords of the existing advertiser satisfying PPC and a number of keywords or clicks which are greater than or equal to a prescribed reference value.

As described above, the advertisement keyword proposing method according to the present exemplary embodiment of the invention may extract the top keyword for sales, that is, a keyword having verified advertisement effects as the representative keyword, thereby achieving advertisement effects of a predetermined level or more.

In operation S630, the advertisement keyword proposing system compares a keyword inputted in association with the new advertiser and the representative keyword of the existing advertiser. Specifically, in operation S630, the advertisement keyword proposing system may compare the top keyword for sales, that is, the representative keyword, from among the advertisement keywords 210 to 230 of the existing advertiser's terminals 101 to 103 and the keyword inputted from the new advertiser's terminal 104.

In operation S640, the advertisement keyword proposing system determines whether the new advertiser has the same business category as that of the existing advertiser according to the above-described compared result. Specifically, in operation S640, the advertisement keyword proposing system may determine that the new advertiser has the same business category as that of the existing advertiser when a conformity rate among keywords is greater than or equal to a prescribed reference value according to the compared result between the keyword inputted from the new advertiser and the representative keyword of the existing advertiser. As an example, according to the compared result between the advertisement keywords 210 to 230 of the existing advertiser's terminals 101 to 103 illustrated in FIG. 2 and the keyword inputted from the new advertiser's terminal 104, in operation S640, the advertisement keyword proposing system may determine that the business category of the new advertiser is a running shoe shopping mall identical to that of the existing advertiser, when the business category of the existing advertiser's terminals 101 and 103 of the advertisement keywords 210 and 230 having the conformity rate among the keywords of 70% or more is the running shoe shopping mall.

Conversely, in operation S640, the advertisement keyword proposing system may determine that the new advertiser has a new business category different from that of the existing advertiser, when the conformity rate is less than a prescribed reference value according to the compared results therebetween.

As described above, the advertisement keyword proposing method according to the present exemplary embodiment of the invention may reduce burdens in that the advertiser has to directly select the business category keyword, and propose advertisement keywords having a relatively high association by supplementing advertisement keywords having a relatively less association due to a conventional associated keyword scheme using the verified keyword for the business category.

In operation S650, the advertisement keyword proposing system designates a predetermined keyword-set as a business category keyword depending on whether the new advertiser and the existing advertiser have the same business category. As an example, in operation S650, the advertisement keyword proposing system may designate a keyword-set operated by the existing advertiser as the business category keyword, when the new advertiser has the same business category as that of the existing advertiser. As an example, in operation S650, the advertisement keyword proposing system may designate the keyword-set extracted by analyzing the home page of the new advertiser as the business category keyword.

In operation S660, the advertisement keyword proposing system proposes, to the new advertiser, the advertisement keyword depending on a result obtained by analyzing the business category keyword. Specifically, in operation S660, the advertisement keyword proposing system may propose, to the new advertiser, remaining business category keywords obtained by eliminating business category keywords in which a click through rate within a fixed period is less than or equal to a prescribed reference value based on the analyzed result of the business category keyword, as the advertisement keywords. Also, in operation S660, the advertisement keyword proposing system may propose, to the new advertiser, business category keywords designated depending on the analyzed result of the home page of the new advertiser as the advertisement keyword, when the new advertiser has a new business category. In addition, in operation S660, the advertisement keyword proposing system may automatically set an advertisement group using the proposed advertisement keyword to expose an advertisement.

As described above, the advertisement keyword proposing method according to the present exemplary embodiment of the invention may automatically set the proposed advertisement keywords as an advertisement group or advertisement campaign to thereby be operated by the advertiser.

Also, the advertisement keyword proposing method according to the present exemplary embodiment of the invention may propose advertisement exposure by setting the advertisement group, and may propose business category-automatic exposure in an automatic exposure scheme.

The advertisement keyword proposing method according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for proposing an advertisement keyword, the method comprising the steps of:
receiving at least one keyword associated with a new advertisement from a new advertiser of the new advertisement;
extracting one or more representative keywords from among advertisement keywords of an existing advertiser having a level of advertising performance that is equal to or exceeds a prescribed reference value;
comparing the at least one keyword associated with the new advertisement of the new advertiser to the one or more representative keywords of the existing advertiser;
determining whether the new advertiser has a same business category as that of the existing advertiser based on a compared result;
designating a predetermined set of keywords as a business category keyword based on a determined result; and
suggesting a set of keywords for the new advertisement to the new advertiser, the set of keywords are determined based on a result obtained by analyzing the predetermined set of keywords of the business category keyword.

2. The method of claim 1, wherein the step of extracting selects, as the representative keyword, a keyword of generating a high advertising revenue that is equal to or exceeds a predetermined value, among the advertisement keywords of the existing advertiser, the advertisement keywords of the existing advertiser satisfying a predetermined value of a pay per click and a number of keywords or clicks.

3. The method of claim 1, wherein the step of determining whether the new advertiser has a same business category as that of the existing advertiser based on a compared result determines that the new advertiser has the same business category as that of the existing advertiser, when a similarity of keywords between the at least one keyword associated with the new advertisement and the one or more representative keywords of the existing advertiser exceeds a predetermined reference value, and
the step of designating designates a set of keywords operated by the existing advertiser as the business category keyword when the new advertiser is determined to have the same business category as that of the existing advertiser.

4. The method of claim 1, wherein the step of suggesting suggests to the new advertiser, a remaining business category keyword acting as the advertisement keyword, the remaining business category keyword being obtained by eliminating a business category keyword in which a click through rate within a fixed period is less than or equal to a prescribed reference value based on the analyzed result of the business category keyword.

5. The method of claim 1, wherein the step of receiving directly receives an input of the at least one keyword from the new advertiser, a keyword used for selecting the business category, or a keyword extracted by analyzing a home page of the new advertiser.

6. The method of claim 1, wherein
the step of determining determines that the new advertiser has a new business category different from that of the existing advertiser, when a similarity of keywords between the at least one keyword associated with the new advertisement and the one or more representative keywords of the existing advertiser is less than a prescribed reference value according to the compared result between the keyword inputted from the new advertiser and the representative keyword of the existing advertiser, and
the step of designating designates a set of keywords extracted by analyzing a home page of the new advertiser as the business category keyword when the new advertiser is determined to be an advertiser of a new business category.

7. The method of claim 1, further comprising:
automatically setting an advertisement group using the suggested advertisement keyword to expose an advertisement.

8. A computer-readable recording medium having stored thereon a computer program that, when executed by one or more processors, causes the one or more processors to perform acts including:
receiving at least one keyword associated with a new advertisement from a new advertiser of the new advertisement;
extracting one or more representative keywords from among advertisement keywords of an existing advertiser having a level of advertising performance that is equal to or exceeds a prescribed reference value;
comparing the at least one keyword associated with the new advertisement of the new advertiser to the one or more representative keywords of the existing advertiser;
determining whether the new advertiser has a same business category as that of the existing advertiser based on a compared result;
designating a predetermined set of keywords as a business category keyword based on a determined result; and
suggesting a set of keywords for the new advertisement to the new advertiser, the set of keywords are determined based on a result obtained by analyzing the predetermined set of keywords of the business category keyword.

9. A system for proposing an advertisement keyword, the system comprising:
a keyword inputting unit for receiving at least one keyword associated with a new advertisement from a new advertiser;
a representative keyword extracting unit for extracting one or more representative keywords from among advertisement keywords of an existing advertiser having a level of advertising performance that is equal to or exceeds a prescribed reference value;
a keyword comparing unit for comparing the at least one keyword associated with the new advertisement of the new advertiser to the one or more representative keywords of the existing advertiser;
a business category determining unit for determining whether the new advertiser has a same business category as that of the existing advertiser based on a compared result;
a business category keyword designating unit for designating a predetermined set of keywords set as a business category keyword based on a determined result; and
an advertisement keyword proposing unit for suggesting a set of keywords for the new advertisement to the new advertiser, the set of keywords are determined based on a result obtained by analyzing the predetermined set of keywords of the business category keyword.

10. The system of claim 9, wherein the representative keyword extracting unit selects, as the representative keyword, a keyword of generating a high advertising revenue that is equal to or exceeds a predetermined value, among the advertisement keywords of the existing advertiser, the advertisement keywords of the existing advertiser satisfying a predetermined value of a pay per click and a number of keywords or clicks.

11. The system of claim 9, wherein
the business category determining unit determines that the new advertiser has the same business category as that of the existing advertiser, when a similarity of keywords between the at least one keyword associated with the new advertisement and the one or more representative keywords of the existing advertiser exceeds a predetermined reference value, and
the business category keyword designating unit designates a set of keywords operated by the existing advertiser as the business category keyword when the new advertiser is determined to have the same business category as that of the existing advertiser.

12. The system of claim 9, wherein the advertisement keyword proposing unit suggests, to the new advertiser, a remaining business category keyword acting as the advertisement keyword, the remaining business category keyword being obtained by eliminating a business category keyword in which a click through rate within a fixed period is less than or equal to a prescribed reference value based on the analyzed result of the business category keyword.

13. The system of claim 9, wherein the keyword inputting unit directly receives an input of the at least one keyword from the new advertiser, a keyword used for selecting the business category, or a keyword extracted by analyzing a home page of the new advertiser.

14. The system of claim 9, wherein
the business category determining unit determines that the new advertiser has a new business category being different from that of the existing advertiser, when a similarity of keywords between the at least one keyword associated with the new advertisement and the one or more representative keywords of the existing advertiser is less than a prescribed reference value according to the compared result between the keyword inputted from the new advertiser and the representative keyword of the existing advertiser, and
the business category keyword designating unit designates a set of keywords extracted by analyzing a home page of the new advertiser as the business category keyword when the new advertiser is determined to be an advertiser of a new business category.

15. The system of claim 1, further comprising:
an advertising exposing unit to automatically set an advertisement group using the suggested advertisement keyword to expose an advertisement.
